(19) United States
(12) Patent Application Publication
(10) Pub. No.: US 2004/0131451 A1
(43) Pub. Date: Jul. 8, 2004

(54) Load pick-up device and method for the storage of articles in an order-picking system

(76) Inventor: Walter Winkler, Parkstein (DE)

Correspondence Address: GRAY CARY WARE & FREIDENRICH LLP, 2000 UNIVERSITY AVENUE, E. PALO ALTO, CA, 94303-2248, US

(21) Appl. No.: 10/099,230

(22) Filed: Mar. 13, 2002

(30) Foreign Application Priority Data
Jan. 31, 2002 (DE) 03 824.4
Mar. 6, 2002 (DE) 102 03 824.4

(51) Int. Cl. B65G 1/00

(52) U.S. Cl. 414/278

(57) ABSTRACT

A load pick-up device for use in an order-picking system with at least one prong is created, which is characterised in that parallel with the longitudinal axis of the prong a pair of conveyor chains connected to a drive and comprising two endlessly revolving conveyor chains is provided, and that the pair of conveyor chains or the prong is connected to a lifting gear for raising or lowering the pair of conveyor chains with respect to the prong, and respectively. In addition, a method for the storing of articles in a rack order-picking system is provided.

The invention relates to a load pick-up device for use in an order-picking system, in particular for the picking up of pallets and small load carriers, together with a method for the storage of articles in the order-picking system with racks.

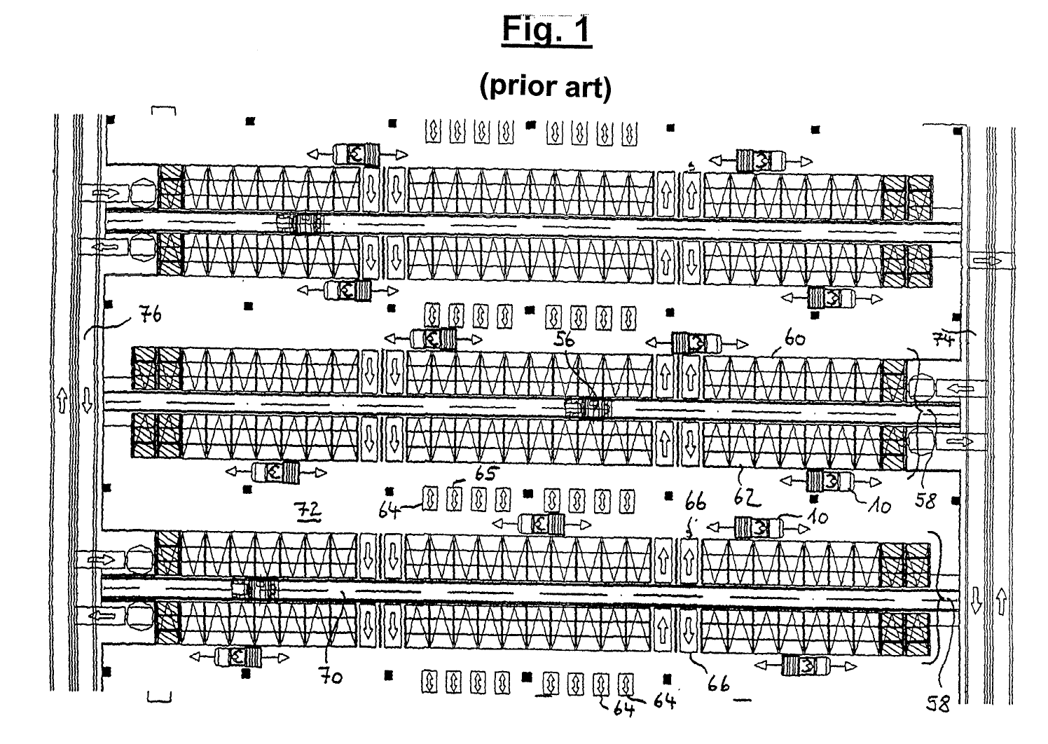

An order-picking system according to the prior art is disclosed, for example, in European patent application EP 1 136 395 A2 under the title “System for the picking of articles located in rack stores”. FIG. 1 shows such an order-picking system.

The system for the picking of articles located in a rack store further comprises: a plurality of parallel rack bays 60 and 62 for the storing of articles located on withdrawal pallets (not shown) and/or in containers (not shown); storage aisles 70, formed alternately between the rack bays 60 and 62 and from which the rack bays 60 and 62 may be filled (again), and pick aisles 72, from which articles may be withdrawn for order-picking; a storage vehicle 56 in each storage aisle 70, which is constructed for the pick-up of at least one picking pallet and/or a container and is conveyable along each individual storage aisle 70 into the pallet racks for the storage of the picking pallets and/or containers; a picker vehicle 10 in each pick aisle 72 for the picking or collection of the articles to be picked up, which is conveyable along one of the two respective pick fronts lying opposite one another and forming the pick aisle 72; buffer places 64, which are arranged in the pick aisles 72 between the conveyance paths of the picker vehicles 10 conveyable along the two opposite pick fronts, for the interim storage of and/or for the transfer of the articles to be picked from a picker vehicle 10 on one side of the pick aisle 72 to a picker vehicle 10 on the other side of the pick aisle 72; and a system control facility with a control computer. In addition to the storage and picking of pallets, the system also permits the storage and picking of containers for smaller articles.

Said small load carriers will also be referred to as “SLCs” below.

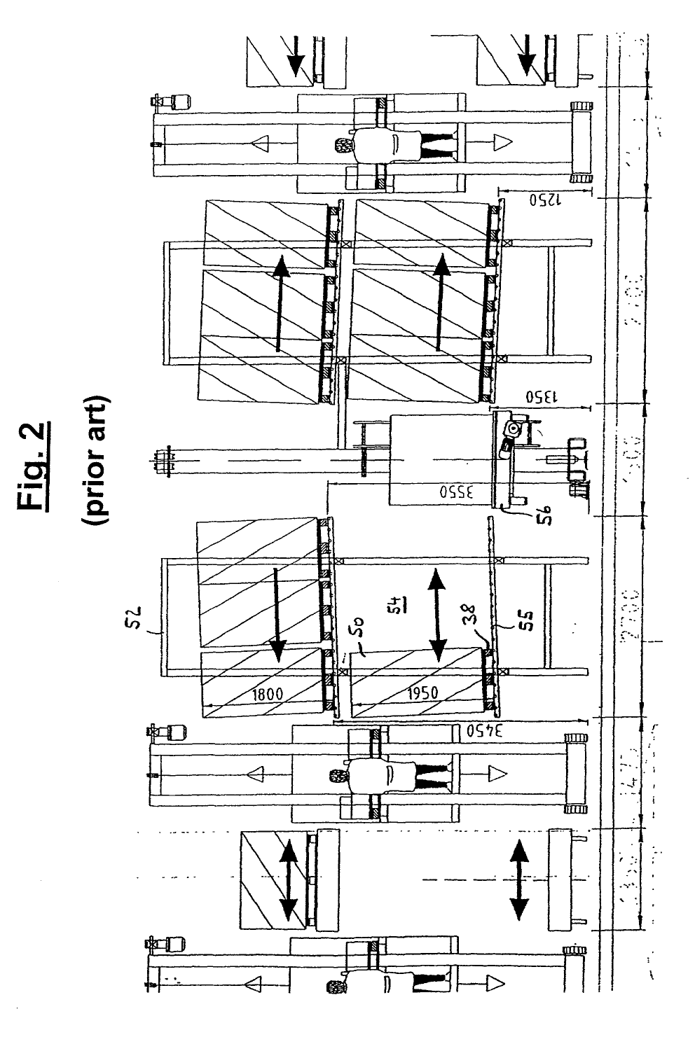

In the prior art the storage of pallets and/or SLCs takes place for example in multi-storey pallet racks 52, such as are shown for example in FIG. 2. In these the pallets may be stored either crosswise or lengthwise from one to three deep. For the order-picking the articles are prepared in picking channels 54 on at least one plane, wherein each picking channel may accommodate up to three pallets one behind the other. As shown, a plurality of picking planes may also be arranged one above the other. The storage of the withdrawal pallets in a storage area, if they no longer carry articles, and the subsequent movement of the withdrawal pallets into the picking channels takes place for example by means of a storage and retrieval unit 56 (cf. also FIG. 1), which in the example of FIG. 1 is able to service two mutually opposite adjacent racks. The automatic storage and retrieval units 56 may be of the conventional type.

It is also possible, however, that in an order-picking system with multi-storey pallet racks picking, i.e. order-picking, takes place from the front side and the storage shafts 54 are filled or replenished from the rear side by means of a conventional fork-lift truck instead of the storage and retrieval unit 56.

Order-picking is performed by the front pallet, the rear pallets are available as reserve. As soon as the front pallet has been cleared, the pallet is withdrawn by the picker and the replenishment pallet(s) rolls/roll forward, for example automatically, across the gravity roller conveyors 55, shown in FIG. 2, of the picking channels 54.

The gravity roller conveyors are inclined slightly with respect to the horizontal. The gravity roller conveyor droops in the picker-front direction, so that positioned pallets or SLCs slide forward on them automatically and independently when a pallet or an SLC is withdrawn out of the storage shaft.

The replenishment of a pallet rack system with a rack vehicle according to the prior art will be explained below.

If one of the storage shafts 54 of the rack picking system is empty (vacated), i.e. a pallet or an SLC is no longer situated in the shaft in order to be used up in an order-picking operation to be executed, pallets or SLCs are as a rule fetched by a storage and retrieval unit 56 out of a storage area (not shown), which lies outside an order-picking area and in which the articles required are stored, and then supplied to the storage shaft 54 to be filled. At the same time a loading surface of the storage and retrieval unit 56, on which the article to be transported is located, is inclined in the direction of the storage shaft by means of a hydraulic apparatus in such a way that the article is conveyed into the storage shaft 54, over rollers situated on the loading surface, by gravity or by means of a gate valve which is attached to the storage and retrieval unit.

If no storage and retrieval unit 56 is provided for loading the storage shafts 54, a conventional fork-lift truck may for example also be used. The fork-lift truck fills the storage shafts from the side of the storage aisles 70. The replenishment operation with a fork-lift truck will be described in detail below, from the fetching of the article out of the storage area up to the supply to, and the final storing in, the storage shaft.

On arrival in the storage area, a fork of the conventional load pick-up device of the fork-lift truck is brought into position below the article to be transported (pallet or SLC), in order thereafter to be raised by a lifting gear which is able to raise and lower the load pick-up device. For the sake of simplicity, the transport of a pallet will be explained below. These remarks also apply to SLCs, however, in which case more extensive details would have to be complied with, which however lie within the normal comprehension of the skilled man, for example that the SLC has both in the storage area and in the storage shaft to be stored in such a way that the fork can be moved in and out beneath the SLC.

After the article has been taken onto the fork, the fork-lift truck is moved to the rack containing the storage shaft to be filled. Depending on the height or level of the storage shaft to be filled, the fork is adjusted in height by the lifting gear and a mast device, to which the load pick-up device is attached, so that the pallet may be introduced by the fork-lift truck into the shaft to be filled by the fork and the article being positioned before the storage shaft in such a way that the fork-lift truck has to be moved ahead in a straight line by only one further fork length. Thereafter the fork is lowered to such an extent that the underside of the pallet rests on the bottom of the storage shaft and is situated between the shaft bottom and the underside of the pallet.

The fork-lift truck is then, in order to move the fork out of the storage shaft, moved away backwards from the pallet rack parallel with the longitudinal or transverse axis of the pallet, depending on the manner in which the shaft to be filled receives the pallets. After the backward movement the fork-lift truck is available for a further storage operation again.

The storage of the pallet with a traditional fork-lift truck is not possible with the use of gravity roller conveyors in the storage shaft, since because of the inclination of the conveyor the pallet may not be deposited over the whole area, but only certain parts of it, so that the extension of the fork with the simultaneous remaining of the pallet in the storage shaft is not possible.

The situation is even more difficult if only SLCs are to be stored in a storage shaft. A depression must be provided on the storage shaft bottom for each prong of the fork, in order that the fork including the SLC may be introduced into the shaft. This requires a still greater precision during the introduction and hence also removal of the whole fork-lift truck than in the case of pallets.

The storage operation is in addition time-consuming and requires a high precision during the manoeuvring in and out of the fork-lift truck, in particular because the storage shafts in the order-picking rack systems are so dimensioned that as many storage shafts as possible fit into a rack, i.e. during the storage of a pallet or an SLC only a small amount of space exists for moving the fork-lift truck in and out.

It is thus an object of the present invention to create a load pick-up device and a method, in particular for a rack vehicle, in a rack order-picking system by means of which a storage operation is to be achieved rapidly and simply.

Further it is an object of the present invention to create a load pick-up device for a rack vehicle with which both pallets and SLCs may be transported and supplied to storage shafts of a rack order-picking system.

The present invention is defined by the independent claims. Preferred embodiments are described in the dependent claims.

According to an aspect of the invention a load pick-up device for use in an order-picking system with at least one prong is created, which is characterised in that parallel with the longitudinal axis of the prong a pair of conveyor chains connected to a drive with two endlessly revolving conveyor chains is provided, and that the pair of conveyor chains is connected in each case to a lifting gear, which is attached to the load pick-up device, for the raising or lowering of the pair of conveyor chains with respect to the prong.

According to another aspect of the invention a load-pickup device for use in an order-picking system with at least one prong is provided, which is characterized in that parallel with the longitudinal axis of the prong a pair of conveyor chains connected to a drive with two endlessly revolving conveyor chains is provided and that the pair of conveyor chains or the prong is connected to a lifting gear for rising or lowering the pair of conveyor chains with respect to the prong and reversely.

According to a preferred embodiment each chain of a pair of conveyor chains is operable forwards and backwards by the drive in synchrony with respect to the other chain of the pair, in order to move an article picked up on the pair of conveyor chains, in particular a pallet or a small load carrier, with respect to the prong.

According to a further preferred embodiment the prong is a telescopic prong which is suitable for a pallet storage one or more deep in longitudinal or transverse direction, and the length of the telescopic prong is variable along its longitudinal axis by the extension or retraction of at least one telescopic prong lengthening piece.

According to a further preferred embodiment the device comprises additionally a scanner with which the position of a picked-up article relative to the prong is determinable.

According to a further preferred embodiment the device comprises additionally centering devices with which the position of a picked-up article relative to the prong is correctable.

According to a further preferred embodiment a common lifting gear for several pairs of conveyor chains is provided.

According to a further preferred embodiment the load pickup device is attached to a rack vehicle of the order-picking system with racks, in order to store articles, in particular pallets and/or small load carriers, in the racks.

According to a further preferred embodiment the rack vehicle comprises: one or two masts with an emergency control position or operator's position; a bogie system; a lifting gear for the prongs; and a braking system. According to a further preferred embodiment the device comprises belts instead of the chains of the pair of conveyor chains.

According to a further aspect of the invention a method is provided for the storage of articles with a device according to the invention in an order-picking system which comprises racks with storage shafts in which the articles are stored, the method comprising the following steps: positioning of the load pick-up device before a rack front of the storage shaft to be filled, so that an end of the pair of conveyor chains that points in the direction of the storage shaft is sufficiently close to the rack front that the article to be stored may fall from the pair of conveyor chains into the storage shaft; raising of the pair of conveyor chains with respect to the prong; and driving of the chains of the pair of conveyor chains so that the article to be stored is moved on the chains in the direction of the storage shaft until such time as the article is stored in the storage shaft.

Further features, embodiments and advantages may be inferred by the skilled man from the following description of the preferred embodiments of the present invention with reference to the attached drawings. In the attached drawings

FIG. 1 shows a diagrammatic rack order-picking system according to the prior art in overhead view,

FIG. 2 a cross-section at right angles to the overhead view of FIG. 1, which represents multi-storey picking racks and associated storage aisles and pick aisles according to the prior art,

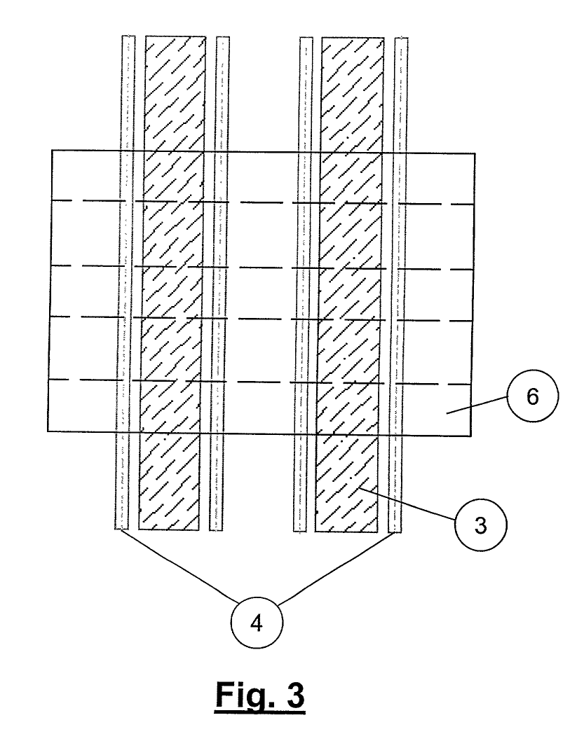

FIG. 3 an overhead view of an embodiment of the present invention with pallet picked up transversely relative to the prongs,

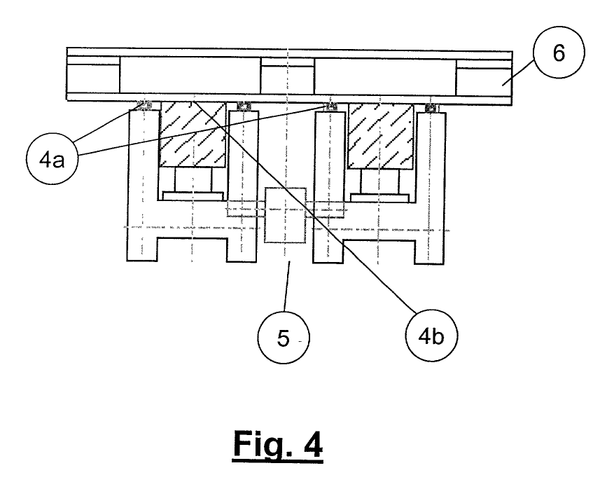

FIG. 4 a side view of FIG. 3 from the front onto the prongs of the load pick-up device according to the invention,

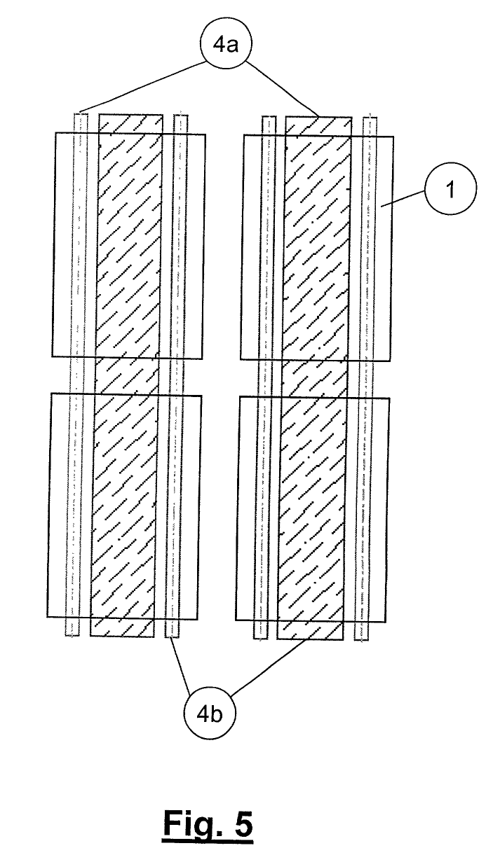

FIG. 5 an overhead view of the embodiment of FIG. 3 with picked-up small load carriers and

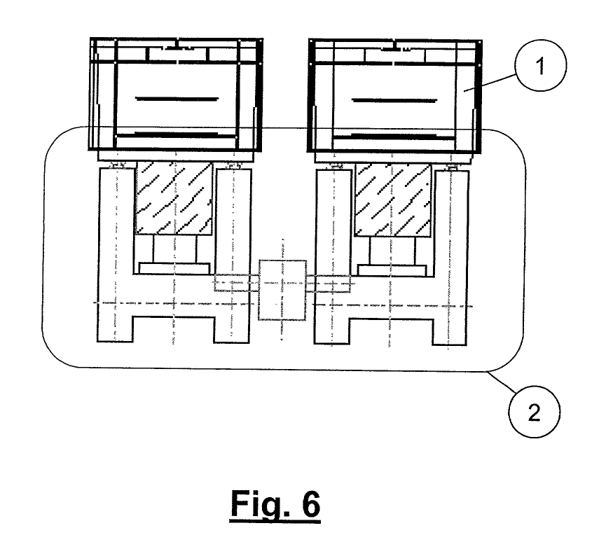

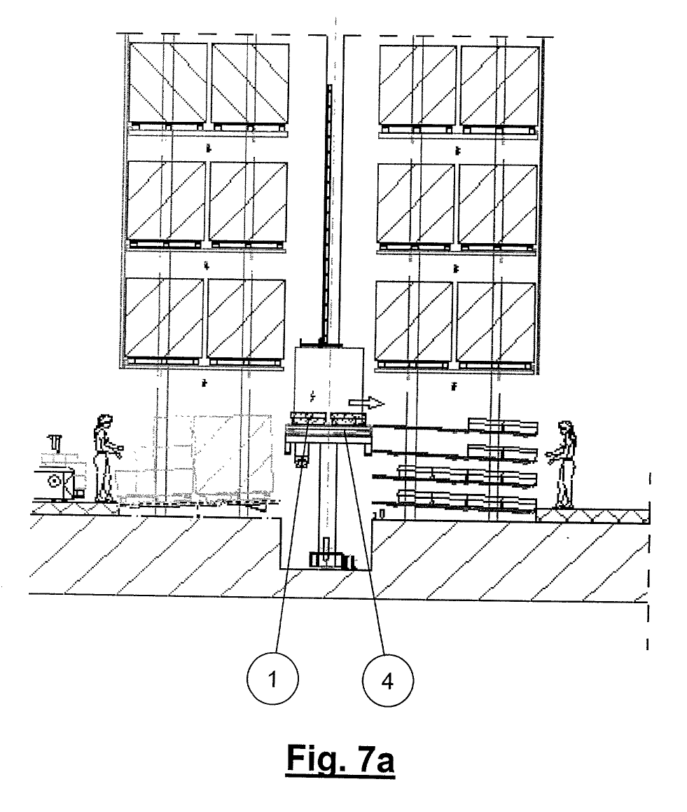

FIG. 6 a side view of FIG. 5,

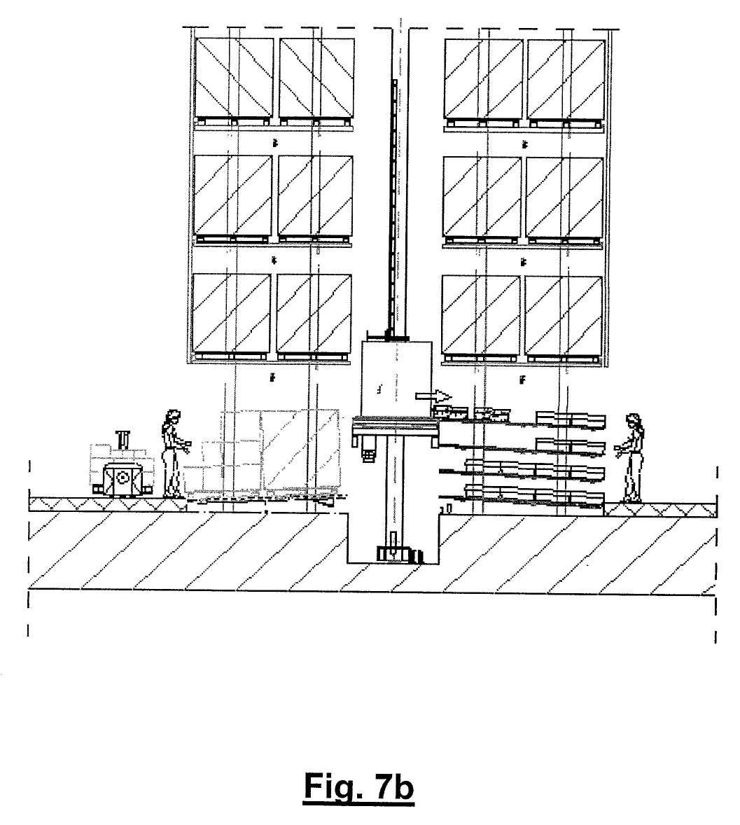

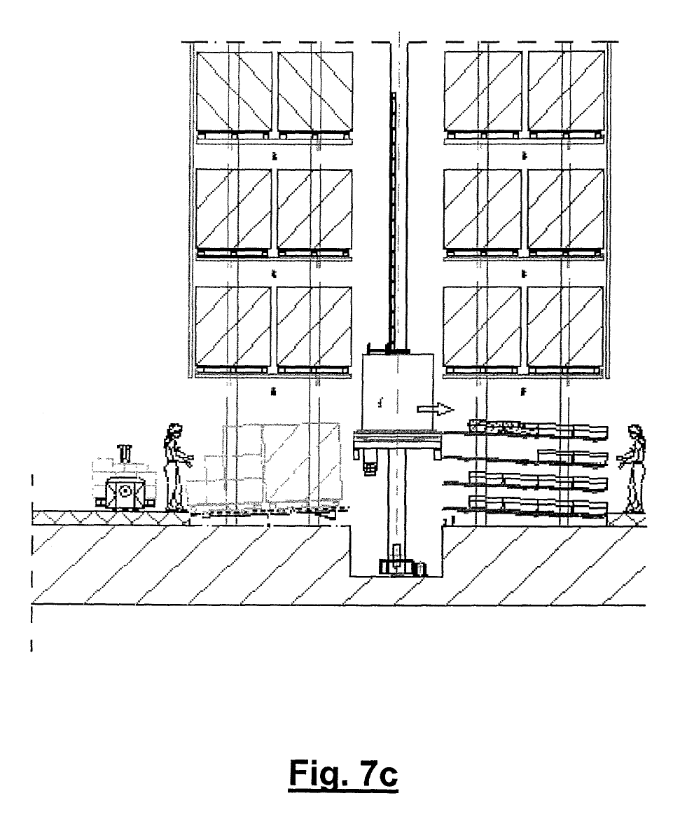

FIGS. 7A to 7C show a diagrammatic storage operation with a load pick-up device according to the invention and

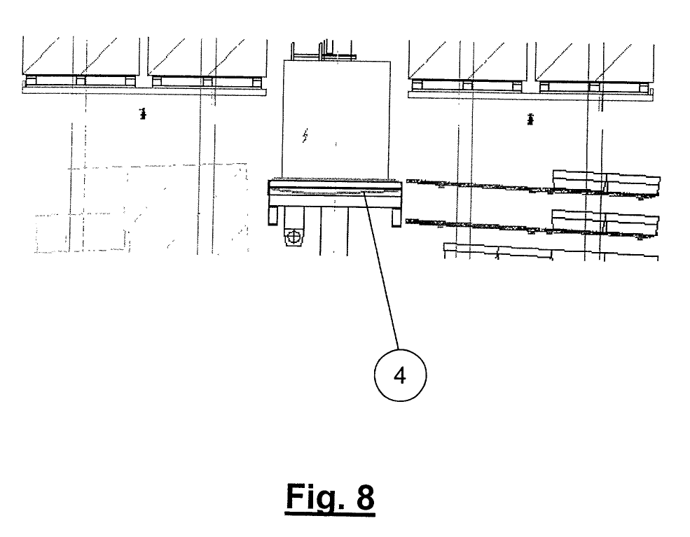

FIG. 8 shows a detailed view of the load pick-up device represented in FIGS. 7A-C.

Described below is a load pick-up device (hereinafter referred to as “LPD”), which may be attached to a rack vehicle (hereinafter referred to as “R”) in order to introduce pallets and/or SLCs into storage shafts of a rack order-picking system. The same elements are designated with identical reference symbols in the figures here. In order-picking systems for articles stored on pallets, articles in containers or trays, said to be in SLCs, are prepared for the order-picking in addition to the pallet articles.

FIG. 3 shows an overhead view of a part of a load pick-up device according to the invention. The LPD comprises in the embodiment of FIG. 3 two prongs 3, which are suitable for a pallet storage one deep in longitudinal or transverse direction. In addition the LPD comprises two pairs of conveyor chains 4, which are arranged parallel with the longitudinal axis of the prongs 3 and comprise in each case two endlessly revolving conveyor chains. In the embodiment of FIG. 3 the two chains 4a and 4b are attached to the left and right respectively of a prong 3 to a lifting gear 5 (not shown) for the prongs. In FIG. 3 a pallet 6 is further positioned transversely on the prongs 3.

FIG. 4 shows a side view of FIG. 3 from the front onto the prongs 3. In this view the common lifting gear 5 for the two pairs of chains 4 is also represented. It is not absolutely necessary, however, for the lifting gear 5 to be responsible for both pairs of chains 4. In an alternative embodiment each pair of chains 4 may possess its own lifting gear 5 in order to be able to raise and lower the pairs of chains separately from one another with respect to the associated prong 3.

The pairs of conveyor chains 4 may be raised and lowered with respect to the prongs 3 with the lifting gear 5. The consequence of this is that if, for example, a pallet 6 is positioned on the prongs 3, the pallet 6 is raised with respect to the prongs 3 during the raising of the previously lowered pairs of conveyor chains 4, so that the pallet 6 stands on the pairs of conveyor chains 4, but no longer on the prongs 3. In order to lift a pallet, at least two prongs 3, i.e. also two pairs of conveyor chains 4, are required. The situation is different with SLCs. A single prong 3 with associated pair of conveyor chains 4 may suffice for the latter.

FIGS. 5 and 6 are almost identical to FIGS. 3 and 4. They differ from FIGS. 3 and 4 in that instead of a pallet 6 four SLCs 1 (two SLCs 1 on each fork) are picked up onto the LPD according to the invention. A greater or lesser number of SLCs, for example only one, may however also be picked up. In addition, in FIG. 6 the LPD 2 is indicated diagrammatically by a rectangle with rounded corners to which the lifting gear 5 for the pairs of chains 4 and the prongs 3 is attached.

As a rule the LPD 2 according to the invention comprises in a similar way to a fork-lift truck—only two prongs 3. This has the advantage that both pallets 6 and SLCs 1 may be transported with the two-pronged LPD 2 according to the invention. Furthermore, the prongs 3 may also be telescopic prongs for retraction and extension, which may be conveyable separately from one another. If there are more than two prongs, both pallets 6 and SLCs 1 may be transported. Thus with a four-pronged LPD 2, for example, two Europallets may be picked up simultaneously side by side and with a three-pronged one a pallet 6 may be picked up by two of the three prongs and simultaneously one or more SLCs by the third prong.

In order to be able to guarantee a pallet storage more than one deep, or to be able to transport more than one pallet simultaneously one behind the other, telescope-like prongs are provided (not shown). A telescope-like prong may—in a similar way to a telescope—be lengthened or shortened in its length by retraction or extension of telescopic elements. Irrespective of the number of prongs used, each telescopic prong may be adjustable in its length separately, in order to enable a desired number of pallets or SLCs to be picked up one behind the other. The description will concern itself by way of example, however, only with storage one deep. It will be quite simple for the skilled man, on the basis of this description, to apply the procedure described for storage one deep to storage more than one deep if he uses telescopic prongs for the prongs.

To return to the initial case already described above: a storage shaft of a rack order-picking system is empty and a pallet and/or an SLC has/have to be replenished. An RV, to which the LPD according to the invention is attached, will fetch out of the storage area a pre-determined article (pallet and/or SLC) and convey it to the empty storage shaft. During the loading in the storage area the article may be loaded with the prongs in a similar way to the procedure described in the prior art.

The RV then travels to the storage shaft to be filled and is positioned with the longitudinal axis of the prongs roughly perpendicular to the front of the rack before the empty storage shaft. The pairs of conveyor chains 4 whose chains 4a and 4b are arranged to the left and right respectively of the prong 3 (cf. FIGS. 3 and 5) are raised with respect to the prong 3 with the lifting gear 5 (cf. FIG. 4). The articles located on the prongs are thereby raised onto the pairs of conveyor chains 4. Each chain 4a and 4b of a pair of conveyor chains 4 is connected to a drive (not shown) by which the endlessly revolving chains 4a and 4b may be driven. For example, if two SLCs 1 are standing on a pair of chains 4, the chains 4a and 4b may be moved in synchrony, so that the SLCs are moved in the direction of the empty storage shaft. The SLCs are conveyed via the end of the pair of conveyor chains 4 that points in the direction of the rack, so that when their centre of gravity projects over the end, they fall forward and downward due to gravity. It naturally has to be ensured here that the pair of chains is not too far removed from the rack front in order that the SLC or the pallet does not fall into a void from the LPD. Assuming, therefore, that the RV is positioned sufficiently close to the rack, the articles located on the moving pairs of conveyor chains fall into the pre-determined storage shafts.

FIGS. 7A to 7C illustrate diagrammatically a procedure for the storage of SLCs in a storage shaft.

In the side view of FIG. 7A an RV containing the LPD according to the invention is located mid-way between two four-storey storage racks. The RV is in this case a single-masted vehicle. One of the endlessly revolving conveyor chains of the pair 4 is distinguished. On the LPD are located two SLCs 1, which are to be stored in the lowest storage shaft of the right-hand storage rack. The storage shaft to be filled is equipped with four gravity roller conveyors arranged one above the other, wherein the topmost conveyor is to be filled. The direction in which the SLCs are to be conveyed, i.e. to the right in FIG. 7A, is indicated by an arrow.

It can be seen from the next FIG. 7B that the right-hand SLC has already been conveyed into the storage shaft by the pair of conveyor chains 4 by chains being rotated in a counter-clockwise direction. The second SLC has not yet been fully conveyed into the storage shaft.

In FIG. 7C the second SLC is also completely transported away from the LPD by means of the driven conveyor chains and has passed into the storage shaft via the gravity roller conveyor.

FIG. 8 represents the LPD according to the invention of FIGS. 7A-C, once again diagrammatically in detail. The endlessly revolving pair of conveyor chains 4 is distinguished in side view.

With one-behind-the-other loading of the prongs more than one deep, for which telescopic prongs are required, the storage may take place by the extended part of the telescopic prongs being introduced into the empty storage shaft (with the aid of the RV) and then the extended part of the telescopic prongs being retracted. The article located on the prongs knocks against the article standing behind it, whereby with further retraction of the prongs the article standing at the front inevitably slips from the prongs. In order not to damage the article, rollers may also be provided in the contact surfaces of the telescopic prongs. When the telescopic prongs have retracted, the last article located on the prongs may be stored in the storage shaft with the aid of the conveyor chains in the manner already described above.

In the case of storage shafts with gravity roller conveyors the articles slide on rollers of the conveyor up to the bottom end of the conveyor, assuming they are loaded from the upper end. If a gravity roller conveyor is not provided in the storage shaft, rollers should be provided in the bottom of the shaft in order that the article may be loaded into it. In this case the article tilts forward from the pair of conveyor chains 4 and due to the further continuing drive of the chains the article is pushed further into the shaft.

The LPD according to the invention may also comprise only one single prong with associated pair of conveyor chains, whereby exclusively SLCs are transported. This has the advantage that an even greater number of different articles may be accommodated in an order-picking system of identical geometric size. The SLCs may for example be so dimensioned that two SLCs side by side, instead of one pallet, fit into a storage shaft.

There are, however, still further advantages of the procedure described above compared with the known method. An LPD according to the invention with at least two prongs and pairs of conveyor chains makes it possible to transport both pallets and SLCs with one and the same vehicle in an order-picking system of the kind described in the preamble. Because the pairs of conveyor chains may be driven and raised and lowered individually, two different storage shafts, which must however lie horizontally next to one another, may also be loaded with SLCs if the RV is moved up to the rack front after being displaced by half a storage shaft width to the left or right. With a suitable choice of the storage shaft arrangement in the rack, articles may thus be loaded into the shafts rapidly and easily with an RV, which may transport both pallets and SLCs. The travel paths of the RVs may be shortened and the number of storage trips required drops.

A forward and backward movement of the RV during the storage is not necessary. The articles are conveyed automatically into the pre-determined storage shaft by the chains. The traditional lowering of the prongs, once they are located in a storage shaft to be filled, is no longer necessary in order to position the article.

The loading of storage shafts with gravity roller conveyors is possible. In the same way, however, shafts with horizontally arranged bottoms may also be loaded if the bottoms are provided with rollers.

The functionality of a traditional LPD without adjustable height pairs of conveyor chains is maintained, since the pairs of chairs are lowerable with respect to the prongs. Instead of a pair of chains, pairs of belts or other means may also be used, which are designed for endless revolution along the prongs.

In a further embodiment of the present invention the pair of conveyor chains is not connected to the lifting gear, but the prongs are connected thereto for rising or lowering the prongs relatively to the pair of conveyor chains. The same applies in such a case that only one single prong having a corresponding pair of conveyor chains is provided.

In addition, centering and/or scanning devices may additionally be provided on the LPD according to the invention, in order that the position of an article on the prongs is determinable and correctable. This prevents an article falling from the prong because it has lost its balance.

The basic equipment of an RV consists of standard components which run in standard logistical systems. These are inter alia: one- and two-masted units with emergency control position or operator's position, bogie system and lifting gear for the LPD, travel aisles with rails and a braking system for the RV.

The skilled man may easily modify or alter the invention described here without exceeding the scope of what is disclosed in the description.

1. Load pick-up device (2) for use in an order-picking system, with at least one prong (3), characterised in that
parallel with the longitudinal axis of the prong (3) a pair of conveyor chains (4) connected to a drive with two endlessly revolving conveyor chains (4a, 4b) is provided, and
that the pair of conveyor chains (4) is connected to a lifting gear (5) for the raising or lowering of the pair of conveyor chains (4) with respect to the prong (3).

2. Load pick-up device (2) for use in an order-picking system, with at least one prong (3), characterised in that
parallel with the longitudinal axis of the prong (3) a pair of conveyor chains (4) connected to the drive with two endlessly revolving conveyor chains (4a, 4b) is provided, and
that the pair of conveyor chains (4) or the prong (3) is connected to a lifting gear (5) for rising or lowering the pair of conveyor chains and/or the prong.

3. Device according to claim 2, in which each chain (4a, 4b) of a pair of conveyor chains (4) is drivable forwards and backwards by the drive in synchrony relative to the other chain (4b, 4a) of the pair, in order to move an article (1, 6) picked up on the pair of conveyor chains (4), in particular a pallet (6) or a small load carrier (1), with respect to the prong (3).

4. Device according to claim 2, in which the prong (3) is a telescopic prong which is suitable for a pallet storage one or more deep in longitudinal or transverse direction, and the length of the telescopic prong is variable along its longitudinal axis by the extension or retraction of at least one telescopic prong lengthening piece.

5. Device according to claim 2, in which the device comprises additionally a scanning device with which the position of a picked-up article (1, 6) relative to the prong (3) is detectable.

6. Device according to claim 2, in which the device comprises additionally centering devices with which the position of a picked-up article (1, 6) relative to the prong (3) is correctable.

7. Device according to claim 2, in which a common lifting gear (5) for several pairs of conveyor chains (4) is provided.

8. Device according to claim 2, in which the load pickup device (2) is attached to a rack vehicle (137) of the order-picking system with racks, in order to store articles (1, 6), in particular pallets (6) and/or small load carriers (1), in the racks.

9. Device according to claim 8, in which the rack vehicle comprises:
one or two masts with an emergency control position or operator's position;
a bogie system;
a lifting gear for the prongs (3); and
a braking system.

10. Device according to claim 2, in which the chains of the pair of conveyor chains are replaced by belts.

11. Method for the storing of articles with a device according to one of claims 1 to 8 in an order-picking system which comprises racks with storage shafts in which the articles are stored, wherein the method comprises the following steps:
positioning of the load pick-up device (2) before a rack front of the storage shaft to be filled, so that an end of the pair of conveyor chains (4) which points in the direction of the storage shaft is sufficiently close to the rack front that the article (1, 6) to be stored may fall from the pair of conveyor chains (4) into the storage shaft;
raising of the pair of conveyor chains (4) with respect to the prong (3); and
driving of the chains (4a, 4b) of the pair of conveyor chains (4) so that the article (1, 6) to be stored is moved on the chains (4a, 4b) in the direction of the storage shaft until such time as the article (1, 6) is stored in the storage shaft.
